(19) United States
(12) Patent Application Publication
(10) Pub. No.: US 2009/0185609 A1
(43) Pub. Date: Jul. 23, 2009

(54) EQUALIZER TEST CIRCUIT AND EQUALIZER TEST SIGNAL GENERATION CIRCUIT

(75) Inventor: Shuichi Takada, Kanagawa-ken (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/354,192

(22) Filed: Jan. 15, 2009

(30) Foreign Application Priority Data
Jan. 21, 2008 (JP) 2008-10345

(51) Int. Cl. H04L 27/01

(52) U.S. Cl. 375/231

(57) ABSTRACT

A test circuit to test an equalizer is disclosed. Pseudo-random number data is generated by a pseudo-random number data generation unit. A weight coefficient is generated by a weight coefficient generation unit in order to set interference strength of intersymbol interference. In a pseudo-intersymbol interference data generation unit, pseudo-intersymbol interference is generated according to a bit sequence of the pseudo-random number data, and pseudo-intersymbol interference data is outputted. An amplitude of the pseudo-intersymbol interference data is changed according to the weight coefficient. A driver converts the pseudo-intersymbol interference data into a differential signal. A comparison unit compares the pseudo-random number data generated by the pseudo-random number data generation unit with output data obtained from the equalizer, when the differential signal outputted from the driver is inputted into the equalizer. A count unit counts the number of unmatched data detected by the comparison unit.

### CROSS REFERENCE TO RELATED APPLICATION

This application is based upon and claims the benefit of priority from the prior Japanese Patent Application No. 2008-10345, filed on Jan. 21, 2008, the entire contents of which are incorporated herein by reference.

### FIELD OF THE INVENTION

The present invention relates to a test circuit to test an equalizer and a test signal generation circuit to generate an equalizer test signal.

### DESCRIPTION OF THE BACKGROUND

In high-speed differential signal transmission using a cable transmission path, intersymbol interference (ISI) occurs in the cable. Due to the intersymbol interference, when the frequency of a signal to be transmitted is high, attenuation of the transmission signal is large.

In order to suppress attenuation of a differential signal to be transmitted, an equalizer is incorporated in a circuit such as an integrated circuit to receive a differential signal, which has passed through a cable. By using the equalizer, an attenuated high-frequency component is corrected to be an original signal waveform.

In order to perform evaluation of the integrated circuit incorporating an equalizer, it is necessary to carry out a performance evaluation of the equalizer. An equalizer and a method of evaluating performance of the equalizer are proposed on page 2 and in FIG. 1 in Japanese Patent Application Publication No. 8-181638, for example.

In the equalizer evaluation test disclosed in the patent publication, signals outputted from a high-frequency signal generator, such as a pseudo-random number generator, are inputted into an equalizer through a cable emulator or an actual cable. The cable emulator emulates characteristics of a cable. This test requires a high-frequency signal generator, which operates at a high-speed, a cable emulator, and other hardware.

A high-speed signal generator is extremely expensive. As to cable emulator, it is difficult to reproduce degradation of a transmission line. Accordingly, the evaluation method of performance of an equalizer, which is disclosed in the patent publication, is not suitable for use in mass production test of integrated circuits.

### SUMMARY OF THE INVENTION

An aspect of the present invention provides a test circuit to test an equalizer including a pseudo-random number data generation unit to generate pseudo-random number data, a weight coefficient generation unit to generate a weight coefficient to set interference strength of intersymbol interference, a pseudo-intersymbol interference data generation unit to generate pseudo-intersymbol interference according to a bit sequence of the pseudo-random number data and to output pseudo-intersymbol interference data, an amplitude of the pseudo-intersymbol interference data being changed according to the weight coefficient, a driver to convert the pseudo-intersymbol interference data into a differential signal, a comparison unit to compare the pseudo-random number data generated by the pseudo-random number data generation unit with output data obtained from the equalizer when the differential signal outputted from the driver is inputted into the equalizer, and a count unit to count the number of unmatched data detected by the comparison unit.

Another aspect of the invention provides an equalizer test signal generation circuit including a pseudo-random number data generation unit to generate pseudo-random number data, a weight coefficient generation unit to generate a weight coefficient to set interference strength of intersymbol interference, a pseudo-intersymbol interference data generation unit to generate pseudo-intersymbol interference according to a bit sequence having a predetermined number of bits of the pseudo-random number data and to output pseudo-intersymbol interference data, an amplitude of the pseudo-intersymbol interference data being changed according to the weight coefficient, and a driver to convert the pseudo-intersymbol interference data into a differential signal and to output the differential signal.

Further another aspect of the invention provides an equalizer test signal generation circuit including a processing circuit to perform a logical operation on a bit sequence having a predetermined number of bits of pseudo-random number data, and an arithmetic circuit, the arithmetic circuit performing a weighting operation by use of the weight coefficient on an amplitude of the pseudo-random number data and on an amplitude of data obtained by a logical operation performed by the processing circuit, the arithmetic circuit adding the two pieces of weighted data to generate and to output pseudo-intersymbol interference data.

### BRIEF DESCRIPTION OF THE DRAWINGS

FIG. 1 is a block diagram showing a first embodiment of an equalizer test circuit according to the present invention.

FIG. 2 is a block diagram showing a configuration of a pseudo-intersymbol interference data generation unit constituting the first embodiment.

FIG. 3 is a diagram showing a circuit example of a driver shown in FIG. 2.

FIG. 4 is a waveform diagram showing an example of an output waveform of the driver shown in FIG. 3.

FIG. 5A and FIG. 5B are views to show the relationship between a weight coefficient and a number of errors.

FIG. 6 is a block diagram showing a pseudo-intersymbol interference data generation unit constituting a second embodiment of an equalizer test circuit according to the present invention.

FIG. 7 is a diagram showing a circuit example of the driver shown in FIG. 6.

FIG. 8 is a waveform diagram showing an example of an output waveform of the driver shown in FIG. 7

FIG. 9 is a block diagram showing an embodiment of an equalizer test signal generation circuit according to the present invention.

### DETAILED DESCRIPTION OF THE INVENTION

Hereinafter, embodiments of the invention will be described with reference to the drawings.

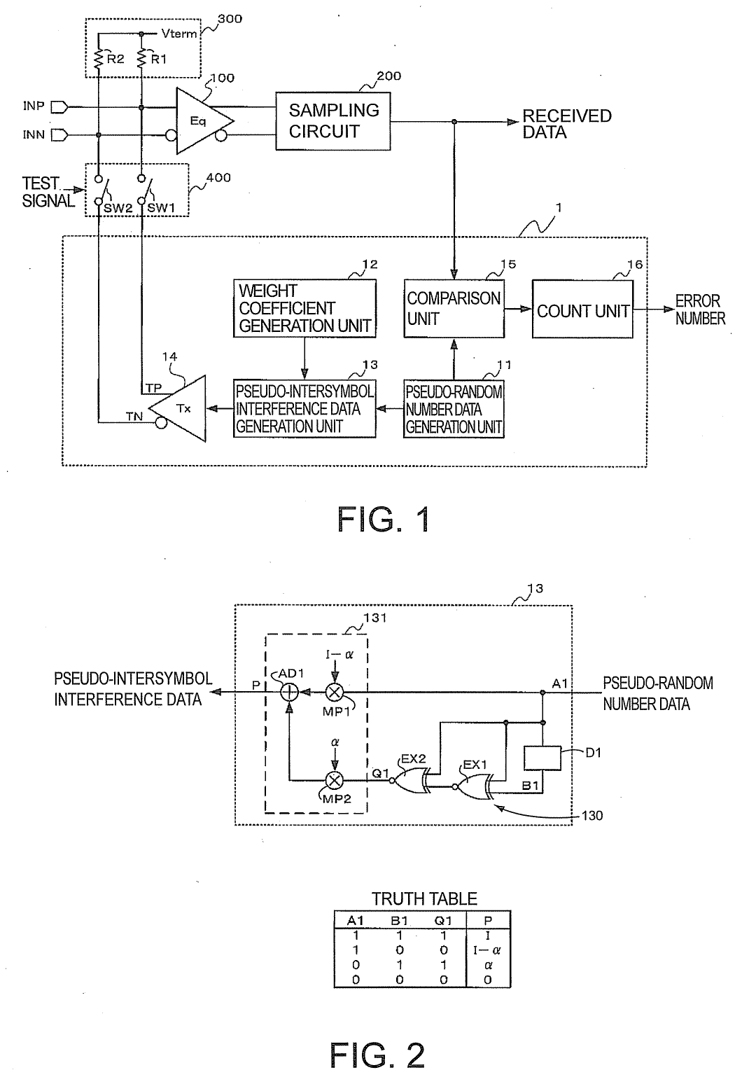

A first embodiment of an equalizer test circuit according to the invention will be described with reference to FIG. 1. FIG. 1 is a block diagram showing the first embodiment of an equalizer test circuit according to the invention.

A test circuit 1 is a circuit to perform a test of an equalizer 100. The equalizer 100 performs waveform equalization of a high-frequency component of a differential signal which is inputted from input terminals INP and INN. The test circuit 1 is provided with a pseudo-random number data generation unit 11 to generate digital pseudo-random data.

The test circuit 1 is further provided with a weight coefficient generation unit 12 to generate a weight coefficient. The weight coefficient is used to set interference strength of intersymbol interference. In accordance with a bit sequence of pseudo-random number data generated by the pseudo-random number data generation unit 11, a pseudo-intersymbol interference data generation unit 13 brings about a pseudo-intersymbol interference in the pseudo-random number data. The amplitude of the generated pseudo-intersymbol interference data is changed according to the weight coefficient generated by the weight coefficient generation unit 12.

The pseudo-intersymbol interference data generated in the pseudo-intersymbol interference data generation unit 13 is outputted as differential signals TP and TN by a driver 14. An output of the equalizer 100 is sent to a sampling circuit 200. Data sampled by the sampling circuit 200 is sent to a comparison unit 15. In the comparison unit 15, the sampled data and the original pseudo-random number data generated by the pseudo-random data generation unit 11 are compared with each other. A comparison result obtained by the comparison unit 15 is sent to a count unit 16. In the count unit 16, the number of unmatched data detected by the comparison unit 15 is counted.

The test circuit 1 is integrated in an integrated circuit together with the equalizer 100 and the sampling circuit 200. A test circuit connection unit 400 includes switches SW1 and SW2. The switches SW1 and SW2 are controlled to open and to close by a test signal. The outputs TP and TN of the driver 14 are connected to the equalizer 100 by the test circuit connection unit 400 only when a test is carried out.

The differential signals INP and INN inputted into the equalizer 100 are also supplied to ends of each of resistances R1 and R2 respectively arranged in a terminal unit 300. The other ends of the resistances R1 and R2 is connected to a power supply (not shown) to provide a terminating potential Vterm.

The pseudo-intersymbol interference data generation unit 13 generates pseudo-intersymbol interference with respect to bit data newly outputted by the pseudo-random number data generation unit 11, in accordance with a bit sequence of the pseudo-random number data. The bit sequence is composed of bits which have been generated before the newly outputted bit data is generated. The bits are predetermined to be up to n bits. The “n” is a voluntary and positive integer.

The weight coefficient generation unit 12 generates n pieces of weight coefficients in accordance with the number n of bits of the bit sequence.

The pseudo-intersymbol interference data generation unit 13 adjusts the change in the amplitude of data obtained by intersymbol interference by use of the n pieces of weight coefficients generated by the weight coefficient generation unit 12.

FIG. 2 shows an example of a circuit configuration of the pseudo-intersymbol interference data generation unit 13 in the case where the number n of bits of the bit sequence is 1 (one).

As shown in FIG. 2, a multiplier MP1, which constitutes an arithmetic unit 131, multiplies bit data A1 newly outputted from the pseudo-random number data generation unit 11 of FIG. 1, by a weight coefficient 1−α. On the other hand, a delay circuit D1 delays an output of the pseudo-random number data generation unit 11 by one bit.

The bit data A1 and the delayed bit data B1, which is one bit before the bit data A1, are inputted into an exclusive NOR circuit EX1. An output of the exclusive NOR circuit EX1 and the bit data A1 are input into an exclusive NOR circuit EX2. An output Q1 of the exclusive NOR circuit EX2 shows a logical relationship between the bit data A1 and the bit data B1, which is one bit before the bit data A1.

A multiplier MP2, which constitutes the arithmetic unit 131, multiplies the output Q1 of the exclusive NOR circuit EX2 by a weight coefficient α. Outputs of the multipliers MP1 and MP2 are inputted into an adder AD1 constituting the arithmetic unit 131. An output P of the adder AD1 is used as pseudo-intersymbol interference data. The delay circuit D1 and the exclusive NOR circuits EX1 and EX2 constitute a processing circuit 130 to perform logical operations.

The truth table of FIG. 2 shows relationships among a value of the bit data A1, a value of the bit data B1 one bit before the bit data A1, the output Q1 of the exclusive NOR circuit EX2 and the output P of the adder AD1.

When the value of both the bit data A1 and the bit data B1, which is one bit before the bit data A1, is 1 (one), the signal strength of pseudo-intersymbol interference data outputted from the pseudo-intersymbol interference data generation unit 13 is I. When the value of both the bit data A1 and the bit data B1, which is one bit before the bit data A1, is 0 (zero), the signal strength is 0 (zero).

In the case where the bit data A1 is 1 (one), if the bit data B1, which is one bit before the bit data A1, is 0 (zero), the signal strength P of the pseudo-intersymbol interference data is I−α. In the case where the bit data A1 is 0 (zero), if the bit data B1, which is one bit before the bit data A1, is 1 (one), the signal strength is α.

The signal strength of the output P is used for output adjustment of the driver 14 of FIG. 1 to receive the output P. Output amplitude of the driver 14 is changed by a signal sequence of newly-outputted bit data and bit data which is one bit before the newly-outputted bit data. When change between the values of the newly-outputted bit data and the bit data, which is one bit before the newly-outputted bit data, happens frequently, i.e. when a high-frequency wave is observed, the attenuation frequency of the amplitude of output of the driver 14, i.e. the frequency of occurrence of intersymbol interference, is high.

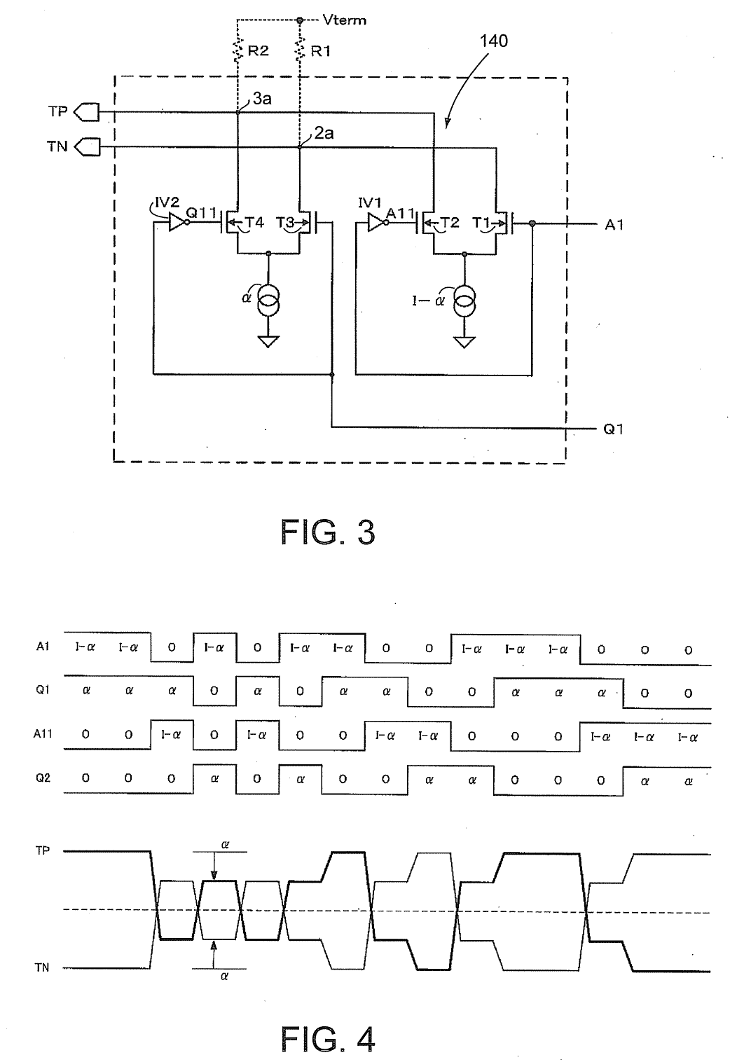

FIG. 3 shows a concrete circuit example of the driver 14. The circuit of FIG. 3 shows a drive circuit 140 integrating the driver 14 and the arithmetic unit 131 shown in FIG. 2.

The bit data A1 outputted from the pseudo-random number data generation unit 11 of FIG. 1 is inputted into an inverter IV1 in FIG. 3. The output Q1 of the exclusive NOR circuit EX2 of the pseudo-intersymbol interference data generation unit 13, which is shown in FIG. 2, is inputted into an inverter IV2.

The bit data A1 is inputted into a gate of a MOS transistor T1. An output A11 of the inverter IV1 is inputted into a gate of a MOS transistor T2. Sources of the MOS transistors T1 and T2 are connected to an electric current source (I−α).

The output Q1 is inputted into a gate of a MOS transistor T3. An output Q11 of the inverter IV2 is inputted into a gate of a MOS transistor T4. Sources of the MOS transistors T3 and T4 are connected to a current source α. The MOS transistors T1 to T4 are an N-channel insulated gate field-effect transistor.

In accordance with the value of the bit data A1, one of the transistors T1 and T2 is made conductive. In accordance with the value of the output Q1, one of the transistors T3 and T4 is made conductive.

The output TP of the driver 14 is an electric current obtained by adding electric currents respectively flowing through the transistors T2 and T4. The output TN is an electric current obtained by adding electric currents respectively flowing through the transistors T1 and T3. The outputs TP and TN of the driver 14 are obtained from connection portions 2a and 3a. When a test is carried out, the outputs TP and TN of the driver 14 are inputted into one ends of the respective resistances R1 and R2 of the terminal unit 300 through the test circuit connection unit 400 of FIG. 1. The other ends of the respective resistances R1 and R2 are connected to a power source (not shown) to provide a terminating potential Vterm.

FIG. 4 shows an example of output waveforms of the drive circuit 140 shown in FIG. 3. FIG. 4 also shows waveforms of the bit data A1 of the pseudo-random number data, the output Q1 of the exclusive NOR circuit EX2, and the outputs A11 and Q11 of the respective inverters IV1 and IV2.

If the bit data A1 of pseudo-random number data outputted from the pseudo-random number data generation unit 11 changes frequently, the amplitudes of the differential outputs TP and TN of the drive circuit 140 are attenuated. The degree of the attenuation depends on the weight coefficient α. When the value of the weight coefficient α is large, the attenuation of the amplitudes of the outputs TP and TN is large.

In FIG. 1, the output of the driver 14 is inputted into the equalizer 100 to be tested. The number of errors is outputted from the count unit 16. When the weight coefficient α is large, the number of errors outputted from the count unit 16 increases.

The reason of the increase of the error number is as follows. When the weight coefficient α is large, a decrease of a high-frequency component of a signal inputted into the equalizer 100 is large. This causes insufficient amplification of the high-frequency component by the equalizer 100. Accordingly, the data sampled by the sampling circuit 200 is different from the original pseudo-random number data, and therefore the number of errors increases.

By monitoring the number of errors outputted from the count unit 16 with the weight coefficient α as a parameter, it is possible to evaluate the equalization performance of the equalizer 100.

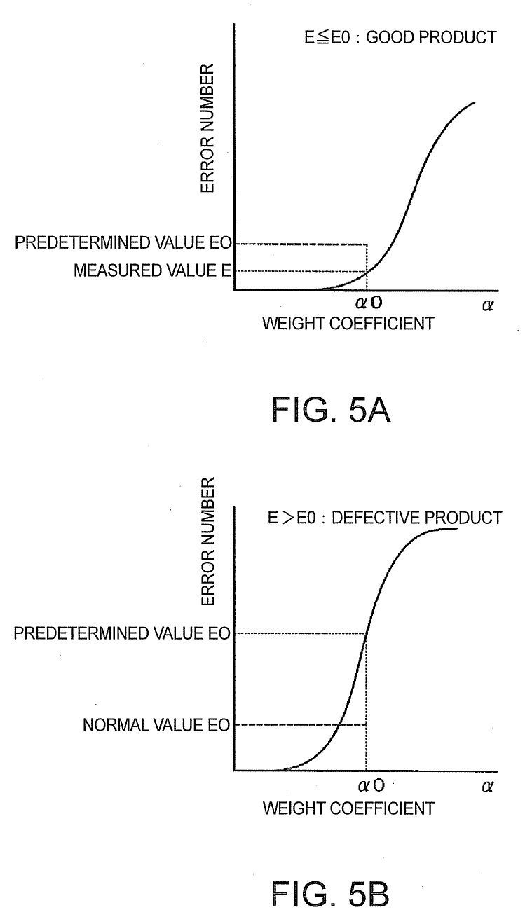

FIG. 5A and FIG. 5B are views each showing the relationship between the weight coefficient α and the number of errors.

FIG. 5A shows an example in which, in the case where a predetermined value of the number of errors relative to a predetermined value α0 of the weight coefficient α is set to E0, an actual measurement value E of the number of errors relative to the predetermined value α0 is E0 or smaller (E<E0). In this case, the equalization performance of the equalizer 100 is judged to be good.

On the other hand, FIG. 5B shows the case where an actual measurement value E of the number of errors relative to the predetermined value α0 of the weight coefficient α is larger than the predetermined value E0 of the number of errors relative to the predetermined value α0 (E>E0). In this case, the equalization performance of the equalizer 100 is judged to be defective.

According to the present embodiment, by generating pseudo-intersymbol interference, it is possible to easily generate pseudo-intersymbol interference data. The degree of attenuation of a high-frequency component by the intersymbol interference can be voluntarily set by a weight coefficient.

Accordingly, with the weight coefficient as a parameter, an evaluation of an equalization performance of an equalizer can be easily carried out. According to the present embodiment, a high-speed signal generator for equalizer evaluation and a cable emulator are not necessary, and therefore the test cost can be reduced.

Furthermore, by integrating an equalizer and a test circuit together in an integrated circuit, a self-diagnosis of the integrated circuit is possible by using the integrated circuit. In the case where an integrated circuit incorporating an equalizer is mass-produced, a test of the equalizer can be easily carried out.

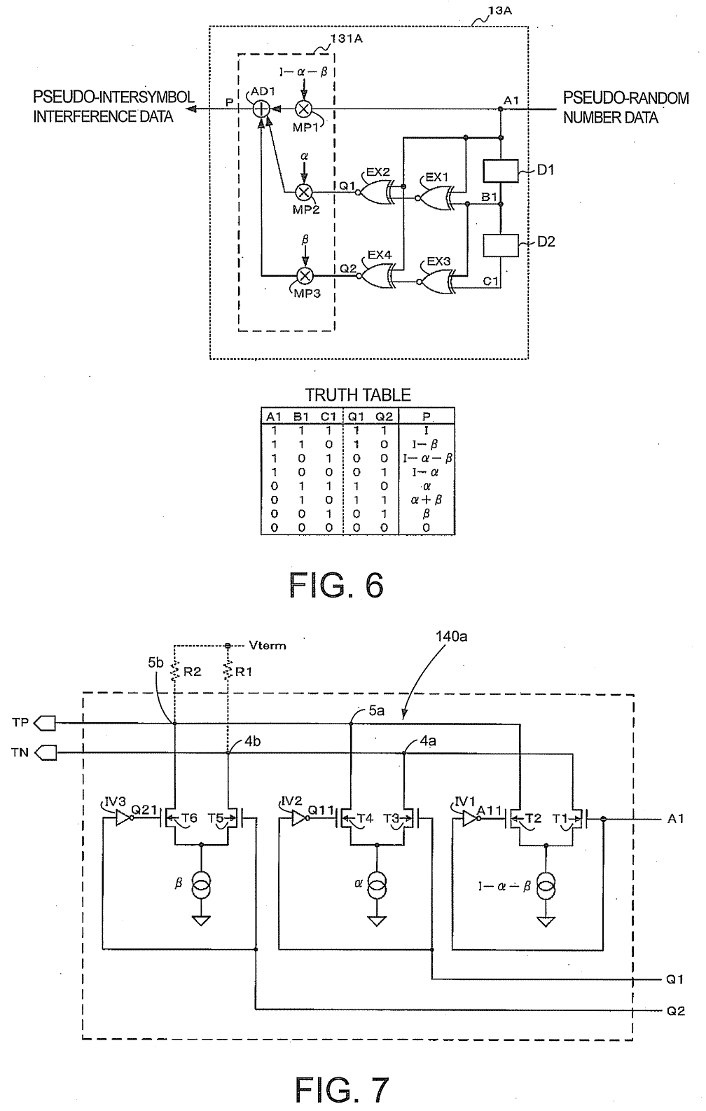

FIG. 6 is a block diagram showing a pseudo-intersymbol interference data generation unit for use in a second embodiment of an equalizer test circuit according to the invention. In FIG. 6, the same reference numerals as those in FIG. 2 respectively indicate the same portions respectively. In the second embodiment, except for the pseudo-intersymbol interference data generation unit, the same configuration as that in FIG. 1 is used.

FIG. 6 shows an example of a circuit configuration of the pseudo-intersymbol interference data generation unit, in the case where a bit number n of a bit sequence for generating intersymbol interference is 2 (two). In the embodiment, in accordance with the bit number, two weight coefficients α and β are outputted from the weight coefficient generation unit 12 of FIG. 1.

In a pseudo-intersymbol interference data generation unit 13A of FIG. 6, bit data A1 newly outputted from the pseudo-random number data generation unit 11 of FIG. 1 is multiplied by a weight coefficient 1−α−β by a multiplier MP1 constituting an arithmetic unit 131A.

An output of the pseudo-random number data generation unit 11 of FIG. 1 is delayed by one bit by the delay circuit D1. Furthermore, an output of the delay circuit D1 is delayed by one bit by a delay circuit D2. The bit data A1 and the delayed bit data B1, which is one bit before the bit data A1, are inputted into the exclusive NOR circuit EX1. An output of the exclusive NOR circuit EX1 and the bit data A1 are inputted into the exclusive NOR circuit EX2.

The bit data B1, which is one bit before the bit data A1, and bit data C1, which is one bit before the bit data B1, are inputted into an exclusive NOR circuit EX3. An output of the exclusive NOR circuit EX3 and the bit data A1 are inputted into the exclusive NOR circuit EX4.

An output Q1 of the exclusive NOR circuit EX2 is multiplied by the weight coefficient α by a multiplier MP2 constituting the arithmetic unit 131A. An output Q2 of the exclusive NOR circuit EX4 is multiplied by the weight coefficient β by a multiplier MP3 constituting the arithmetic unit 131A.

Outputs of the multipliers MP1 to MP3 are inputted into an adder AD1 constituting the arithmetic unit 131A. An output P of the adder AD1 is used as pseudo-intersymbol interference data.

The truth table of FIG. 6 shows relationships among a value of the bit data A1, a value of the bit data B1 which is one bit before the bit data A1, the value of the bit data C1 which is one bit before the bit data B1, and the outputs Q1 and Q2 of the respective exclusive NOR circuits EX2 and EX4, and the output P of the adder AD1.

In the circuit shown in FIG. 6, the signals Q1 and Q2 show logical relationships among the new bit data A1 of pseudo-random number data, the bit data B1 which is one bit before the bit data A1, and the bit data C1 which is two bit before the bit data A1. By inputting the bit data A1 and the signals Q1 and Q2 into the arithmetic unit 131A, arithmetic operations among the signals Q1 and Q2 and the weight coefficients α and β are performed.

The signal Q1 shows a logical relationship between the bit data A1 and the bit data B1. The signal Q2 shows a logical relationship between data showing the bit data B1 and the bit data C1 and the bit data A1. The signal Q1 shows a trend of change of value of a bit data which is one bit before newly-inputted bit data. The signal Q2 shows a trend of change of values of bit data which is one bit before and which is two bit before newly-inputted bit data.

The arithmetic circuit 131A performs a weighting operation on the bit data A with (I−α−β). The arithmetic circuit 131A performs weighting operations on the signal Q1 with α and on the signal Q2 with β, respectively, and then adds results of the weighting operations together.

By these operations, the pseudo-intersymbol interference data P, which is outputted from the pseudo-intersymbol interference data generation unit 13A, is maintained at the original signal strength I or 0 (zero), when the values of the newly-inputted bit data A1, the bit data B1 one bit before the bit data A1, and the bit data C1 two bit before the bit data A1 are the same. In the case where there is a variation among the values of the bit data A1, B1, and C1, the signal strength is a value related to the weight coefficients α and β as shown in the truth table of FIG. 6 in accordance with the variation of the values.

If the relationship between the weight coefficients is set to β<α, the degree of effect of the bit data C2 two bit before the newly-inputted bit data A1 on the bit data A1 can be made smaller than the degree of effect of the bit data B1 one bit before the bit data A1 on the bit data A1.

FIG. 7 shows an actual example of a drive circuit used, instead of the driver 14 of FIG. 1, in the present embodiment. A drive circuit 140a shown in FIG. 7 is a circuit integrating the arithmetic unit 131A of FIG. 6 and the driver 14 of FIG. 1. In FIG. 7, the same reference numerals as those in FIG. 3 respectively indicate the same portions.

In the drive circuit 140a of FIG. 7, an inverter IV3 and MOS transistors T5 and T6 as an insulated gate field effect transistor are added to the drive circuit 140 of FIG. 3. The output Q2 is inputted into the inverter IV3 and a gate of the MOS transistor T5. An output of the inverter IV3 is inputted into a gate of the MOS transistor T6. Sources of the MOS transistors T5 and T6 are connected to an electric current source B. When a test is carried out, drains of the MOS transistors T5 and T6 are respectively connected to the resistances R1 and R2 to be provided with a terminating potential Vterm. Sources of the MOS transistors T1 and T2 are connected to the electric current source (I−α−β).

In accordance with the value of the bit data A1 inputted into the drive circuit 140a, one of the transistor T1 to receive the bit data A1 and the transistor T2 to receive an output A11 from the inverter IV1 is made conductive. In accordance with the value of the input Q1, one of the transistor T3 and the transistor T4 to receive the output Q11 from the inverter IV2 is made conductive. In accordance with the value of the input Q2, any one of the transistors T5 and T6 is made conductive.

As the output TP of the drive circuit 140a, an electric current obtained by adding electric currents respectively flowing through the transistors T2, T4, and T6 is outputted. As the output TN of the driver 14A, an electric current obtained by adding electric currents respectively flowing through the transistors T1, T3, and T5 is outputted.

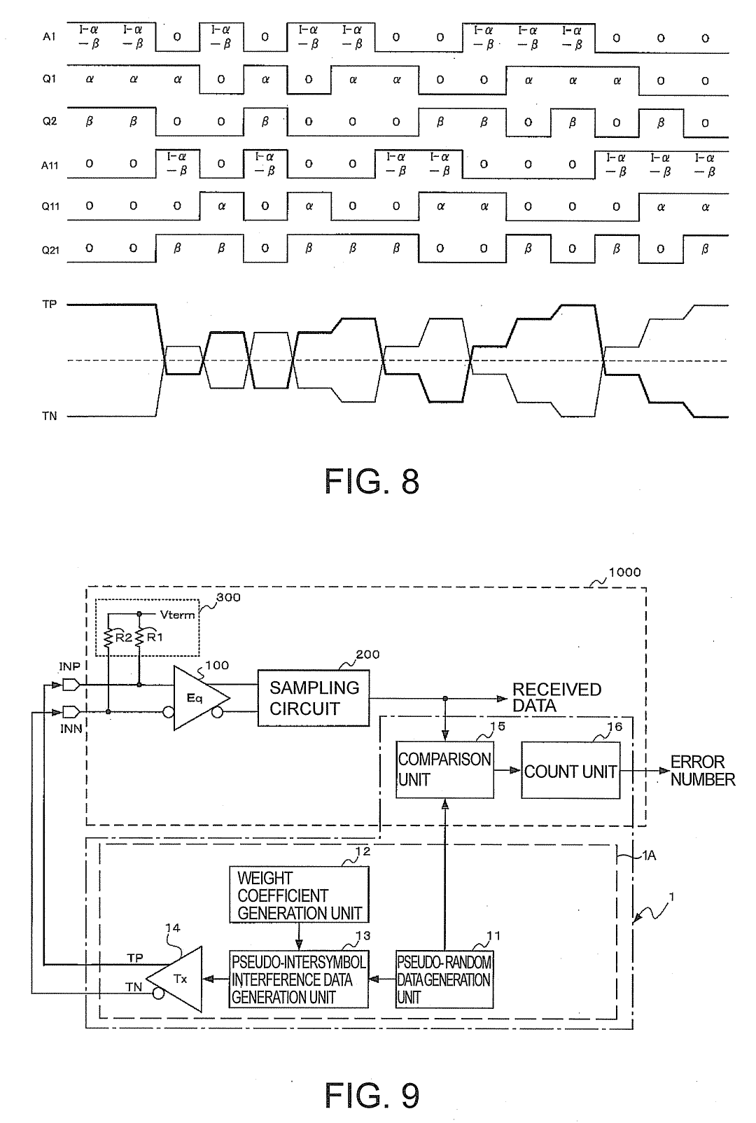

In FIG. 8, an example of waveforms of the outputs TP and TN of the drive circuit 140a of FIG. 7 is shown. FIG. 8 shows waveforms of the bit data A1 of pseudo-random number data, the outputs Q1 and Q2 of the respective exclusive NOR circuits EX2 and EX4, and the outputs A11, Q11, and Q12 of the respective inverters IV1, IV2, and IV3 as well.

The output waveforms in FIG. 8 show more complicated shapes than those of the drive circuit 140 of the first embodiment shown in FIG. 4.

According to the present embodiment, change in bit data up to two bit before newly-inputted bit data can reflect the newly-inputted bit data. Accordingly, in the present embodiment, more complicated pseudo-intersymbol interference data can be generated. Therefore, a more accurate evaluation of equalization properties of an equalizer can be carried out.

FIG. 9 is a block diagram showing an embodiment of an equalizer test signal generation circuit according to the invention. In FIG. 9, the same reference numerals as those in FIG. 1 respectively indicate the same portions. The test signal generation circuit according to the embodiment is substantially composed of portions of the test circuit shown in FIG. 1.

A test signal generation circuit 1A of the present embodiment includes the pseudo-random number data generation unit 11, the weight coefficient generation unit 12, the pseudo-intersymbol interference data generation unit 13, and the driver 14. Pseudo-random number data is outputted from the pseudo-random number data generation unit 11. Differential outputs TP and TN are outputted from the driver 14.

An integrated circuit 1000 to be tested incorporates the equalizer 100, the sampling circuit 200, the comparison unit 15, the count unit 16, and the terminal unit 300. A circuit composed of the test signal generation circuit 1A, the comparison unit 15, and the count unit 16 are substantially contained in the test circuit 1 in FIG. 1. The test signal generation circuit 1A is installed outside of the integrated circuit 1000.

From the count unit 16 of the integrated circuit 1000, the number of errors can be obtained. Accordingly, the integrated circuit 1000 is capable of carrying out an evaluation of the equalizer 100. The terminal unit 300 includes resistances R1 and R2 connected to a power source (not shown) to provide a terminating potential Vterm.

When a test of the equalizer 100 is carried out, two output terminals of the driver 14 are respectively connected to two input terminals of the integrated circuit 1000 (of the equalizer 100). Pseudo-intersymbol interference data, which is generated in the pseudo-intersymbol interference data generation unit 13 of the test signal generation circuit 1A and which is made into a differential signal by the driver 14, is inputted into the equalizer 100.

Pseudo-random number data from the pseudo-random number data generation unit 11 is inputted into the comparison unit 15. In the comparison unit 15, the pseudo-random number data and an output of the sampling circuit 200 are compared. An output of the comparison unit 15 is sent to the count unit 16, and the number of errors is obtained.

According to the embodiment, a test of an equalizer in mass-production of the integrated circuit 1000 can be easily carried out.

The integrated circuit 1000 does not incorporate the pseudo-random number data generation unit 11, the weight coefficient generation unit 12, the pseudo-intersymbol interference data generation unit 13, and the driver 14. Therefore, the chip size of the integrated circuit 1000 incorporating the equalizer 100 can be made smaller.

Other embodiments or modifications of the present invention will be apparent to those skilled in the art from consideration of the specification and practice of the invention disclosed herein. It is intended that the specification and example embodiments be considered as exemplary only, with a true scope and spirit of the invention being indicated by the following.

What is claimed is:

1. A test circuit to test an equalizer, comprising:
a pseudo-random number data generation unit to generate pseudo-random number data;
a weight coefficient generation unit to generate a weight coefficient to set interference strength of intersymbol interference;
a pseudo-intersymbol interference data generation unit to generate pseudo-intersymbol interference according to a bit sequence of the pseudo-random number data and to output pseudo-intersymbol interference data, an amplitude of the pseudo-intersymbol interference data being changed according to the weight coefficient;
a driver to convert the pseudo-intersymbol interference data into a differential signal;
a comparison unit to compare the pseudo-random number data generated by the pseudo-random number data generation unit with output data obtained from the equalizer when the differential signal outputted from the driver is inputted into the equalizer; and
a count unit to count the number of unmatched data detected by the comparison unit.

2. The test circuit according to claim 1, wherein the pseudo-intersymbol interference data generation unit includes:
a processing circuit to perform a logical operation on a bit sequence having a predetermined number of bits of pseudo-random number data; and
an arithmetic circuit, the arithmetic circuit performing a weighting operation by use of the weight coefficient on an amplitude of the pseudo-random number data and on an amplitude of data obtained by a logical operation performed by the processing circuit, the arithmetic circuit adding the two pieces of weighted data to generate and to output pseudo-intersymbol interference data.

3. The test circuit according to claim 2, wherein the processing circuit outputs a signal showing a logical relationship between newly inputted bit data and bit data one bit before the newly inputted bit data among the pseudo-random number data.

4. The test circuit according to claim 1, wherein the pseudo-intersymbol interference data generation unit includes:
a first delay circuit to delay the pseudo-random number data by one bit;
a first exclusive NOR circuit to receive the pseudo-random number data and an output of the first delay circuit;
a second exclusive NOR circuit to receive an output of the pseudo-random number data and an output of the first exclusive NOR circuit;
a first multiplier to receive the pseudo-random number data, the first multiplier multiplying the pseudo-random number data by a first weight coefficient generated by the weight coefficient generation unit,
a second multiplier to receive an output of the second exclusive NOR circuit, the second multiplier multiplying the output of the second exclusive NOR circuit by a second weight coefficient generated by the weight coefficient generation unit; and
an adder to receive outputs of the first and the second multipliers, the adder outputting the pseudo-intersymbol interference data.

5. The test circuit according to claim 4, wherein
the pseudo-intersymbol interference data generation unit further includes:
a second delay circuit to delay an output of the first delay circuit by one bit;
a third exclusive NOR circuit to receive outputs of the first and the second delay circuits;
a fourth exclusive NOR circuit to receive an output of the third exclusive NOR circuit and the pseudo-random number data; and
a third multiplier to multiply an output of the fourth exclusive NOR circuit by a third weight coefficient generated by the weight coefficient generation unit, and wherein
the pseudo-intersymbol interference data generation unit inputs an output of the third multiplier into the adder.

6. The test circuit according to claim 2, wherein the arithmetic circuit and the driver constitute a drive circuit, the drive circuit includes:
a first electric current source corresponding to a first weight coefficient;
a second electric current source corresponding to a second weight coefficient;
a first inverter to receive the pseudo-random number data;
a second inverter to receive a first output of the processing circuit;
a first field effect transistor, a gate of the first field effect transistor receiving the pseudo-random number data, a source of the first field effect transistor being connected to the first electric current source;
a second field effect transistor, a gate of the second field effect transistor receiving an output of the first inverter, a source of the second field effect transistor being connected to the first electric current source;
a third field effect transistor, a gate of the third field effect transistor receiving the first output of the processing circuit, a source of the third field effect transistor being connected to the second electric current source; and
a fourth field effect transistor, a gate of the fourth field effect transistor receiving an output of the second inverter, a source of the fourth field effect transistor being connected to the second electric current source, and wherein
drains of the first and the third field effect transistors are connected to each other so as to form a first connection portion,
drains of the second and the fourth field effect transistors are connected to each other so as to form a second connection portion, and
the differential signal is obtained from the first and second connection portions.

7. The test circuit according to claim 6, further comprising:
a third electric current source corresponding to a third weight coefficient;
a third inverter to receive a second output of the processing circuit;
a fifth field effect transistor, a gate of the fifth field effect transistor receiving the second output of the processing circuit, a source of the fifth field effect transistor being connected to the third electric current source; and
a sixth field effect transistor, a gate of the sixth field effect transistor receiving an output of the third inverter, a source of the sixth field effect transistor being connected to the third electric current source, wherein
a drain of the fifth field effect transistor is connected to the first connection portion, and
a drain of the sixth field effect transistor is connected to the second connection portion.

8. The test circuit according to claim 1, wherein, a switch is provided to connect the driver with the equalizer.

9. The test circuit according to claim 1, wherein
a value of the weight coefficient generated by the weight coefficient generation unit is changed, and
performance of the equalizer is evaluated based on change characteristics of a count value of the count unit relative to the change of the value of the weight coefficient.

10. An equalizer test signal generation circuit, comprising
a pseudo-random number data generation unit to generate pseudo-random number data;
a weight coefficient generation unit to generate a weight coefficient to set interference strength of intersymbol interference;
a pseudo-intersymbol interference data generation unit to generate pseudo-intersymbol interference according to a bit sequence having a predetermined number of bits of the pseudo-random number data and to output pseudo-intersymbol interference data, an amplitude of the pseudo-intersymbol interference data being changed according to the weight coefficient; and
a driver to convert the pseudo-intersymbol interference data into a differential signal and to output the differential signal.

11. The equalizer test signal generation circuit according to claim 10, wherein the pseudo-intersymbol interference data generation unit includes:
a processing circuit to perform a logical operation on a bit sequence having a predetermined number of bits of pseudo-random number data;
an arithmetic circuit, the arithmetic circuit performing a weighting operation by use of the weight coefficient on an amplitude of the pseudo-random number data and on an amplitude of data obtained by a logical operation performed by the processing circuit, the arithmetic circuit adding the two pieces of weighted data to generate and to output pseudo-intersymbol interference data.

12. The equalizer test signal generation circuit according to claim 11, wherein the processing circuit outputs a signal showing a logical relationship between newly inputted bit data and bit data one bit before the newly inputted bit data among the pseudo-random number data.

13. The equalizer test signal generation circuit according to claim 10, wherein the pseudo-intersymbol interference data generation unit includes:
a first delay circuit to delay the pseudo-random number data by one bit;
a first exclusive NOR circuit to receive the pseudo-random number data and an output of the first delay circuit;
a second exclusive NOR circuit to receive an output of the pseudo-random number data and an output of the first exclusive NOR circuit;
a first multiplier to receive the pseudo-random number data, the first multiplier multiplying the pseudo-random number data by a first weight coefficient generated by the weight coefficient generation unit;
a second multiplier to receive an output of the second exclusive NOR circuit, the second multiplier multiplying the output of the second exclusive NOR circuit by a second weight coefficient generated by the weight coefficient generation unit; and
an adder to receive outputs of the first and the second multipliers, the adder outputting the pseudo-intersymbol interference data.

14. The equalizer test signal generation circuit according to claim 13, wherein
the pseudo-intersymbol interference data generation unit further includes:
a second delay circuit to delay an output of the first delay circuit by one bit;
a third exclusive NOR circuit to receive outputs of the first and the second delay circuits;
a fourth exclusive NOR circuit to receive an output of the third exclusive NOR circuit and the pseudo-random number data; and
a third multiplier to multiply an output of the fourth exclusive NOR circuit by a third weight coefficient generated by the weight coefficient generation unit, and wherein
the pseudo-intersymbol interference data generation unit inputs an output of the third multiplier into the adder.

15. The equalizer test signal generation circuit according to claim 11, wherein the arithmetic circuit and the driver constitute a drive circuit, the drive circuit includes:
a first electric current source corresponding to a first weight coefficient;
a second electric current source corresponding to a second weight coefficient;
a first inverter to receive the pseudo-random number data;
a second inverter to receive an output of the processing circuit;
a first field effect transistor, a gate of the first field effect transistor receiving the pseudo-random number data, a source of the first field effect transistor being connected to the first electric current source;
a second field effect transistor, a gate of the second field effect transistor receiving an output of the first inverter, a source of the first field effect transistor being connected to the first electric current source;
a third field effect transistor, a gate of the third field effect transistor receiving the output of the processing circuit, a source of the third field effect transistor being connected to the second electric current source; and
a fourth field effect transistor, a gate of the fourth field effect transistor receiving an output of the second inverter, a source of the fourth field effect transistor being connected to the second electric current source, and wherein
drains of the first and the third field effect transistor are connected to each other so as to form a first connection portion,
drains of the second and the fourth field effect transistor are connected to each other so as to form a second connection portion, and
the differential signal is outputted from the first and the second connection portion.

16. The equalizer test signal generation circuit according to claim 15, further comprising:
a third electric current source corresponding to a third weight coefficient;
a third inverter to receive a second output of the processing circuit;
a fifth field effect transistor, a gate of the fifth field effect transistor receiving the second output of the processing unit, a source of the fifth field effect transistor being connected to the third electric source; and
a sixth field effect transistor, a gate of the sixth field effect transistor receiving an output of the third inverter, a source of the sixth field effect transistor being connected to the third electric current source, wherein
a drain of the fifth field effect transistor is connected to the first connection portion, and
a drain of the sixth field effect transistor is connected to the second connection portion.

17. An equalizer test signal generation circuit, comprising:
a processing circuit to perform a logical operation on a bit sequence having a predetermined number of bits of pseudo-random number data; and
an arithmetic circuit, the arithmetic circuit performing a weighting operation by use of the weight coefficient on an amplitude of the pseudo-random number data and on an amplitude of data obtained by a logical operation performed by the processing circuit, the arithmetic circuit adding the two pieces of weighted data to generate and to output pseudo-intersymbol interference data.

18. The equalizer test signal generation circuit according to claim 17, wherein the processing circuit outputs a signal showing a logical relationship between newly inputted bit data and bit data one bit before the newly inputted bit data among the pseudo-random number data.

19. The equalizer test signal generation circuit according to claim 17, wherein the processing circuit includes:
a first delay circuit to delay the pseudo-random number data by one bit;
a first exclusive NOR circuit to receive the pseudo-random number data and an output of the first delay circuit; and
a second exclusive NOR circuit to receive an output of the pseudo-random number data and an output of the first exclusive NOR circuit, and
the arithmetic circuit includes:
a first multiplier to receive the pseudo-random number data, the first multiplier multiplying the pseudo-random number data by a first weight coefficient generated by the weight coefficient generation unit;
a second multiplier to receive an output of the second exclusive NOR circuit, the second multiplier multiplying the output of the second exclusive NOR circuit by a second weight coefficient generated by the weight coefficient generation unit; and
an adder to receive outputs of the first and the second multipliers, the adder outputting the pseudo-intersymbol interference data.

20. The equalizer test signal generation circuit according to claim 19, wherein
the pseudo-intersymbol interference data generation unit further includes:
a second delay circuit to delay an output of the first delay circuit by one bit;
a third exclusive NOR circuit to receive outputs of the first and the second delay circuits;
a fourth exclusive NOR circuit to receive an output of the third exclusive NOR circuit and the pseudo-random number data; and
a third multiplier to multiply an output of the fourth exclusive NOR circuit by a third weight coefficient generated by the weight coefficient generation unit, and wherein
the pseudo-intersymbol interference data generation unit inputs an output of the third multiplier into the adder.
